(19) United States
(12) Patent Application Publication
(10) Pub. No.: US 2014/0331834 A1
(43) Pub. Date: Nov. 13, 2014

(54) Groundable pipe cutter

(71) Applicants: L. Herbert King, JR., Jupiter, FL (US); James C. Keeven, O'Fallon, MO (US)

(72) Inventors: L. Herbert King, JR., Jupiter, FL (US); James C. Keeven, O'Fallon, MO (US)

(21) Appl. No.: 13/999,930

(22) Filed: Apr. 4, 2014

Related U.S. Application Data
(60) Provisional application No. 61/855,079, filed on May 8, 2013.

(51) Int. Cl. B26D 3/16

(52) U.S. Cl. CPC B26D 3/169
USPC 83/13; 30/92

(57) ABSTRACT

A groundable pipe cutter having an electrically conductive blade and a grounding terminal for attachment to an electrical ground to prevent accidental sparking when cutting a pipe.

### CROSS REFERENCE TO RELATED APPLICATIONS

This application claims priority from provisional application 61/855,079 filed May 8, 2013.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

### SUMMARY OF THE INVENTION

A groundable pipe cutter having an electrically conductive blade and a terminal for attachment of a ground clip thereto to prevent accidental sparking that may cause an explosion with a flammable fluid within a pipe being cut by the groundable pipe cutter.

### BRIEF DESCRIPTION OF THE DRAWINGS

FIG. 1 is a front view of a groundable pipe cutter;

FIG. 2 is an isolated view of a terminal pivot pin of the groundable pipe cutter of FIG. 1;

FIG. 2A is an isolated view of an alternate embodiment of a terminal pivot pin for the groundable pipe cutter of FIG. 1;

FIG. 2B is an end view of a terminal pivot pin having a socket therein; and

FIG. 3 is partial view showing the terminal pivot pin with a clamp and ground rod secured thereto.

### DESCRIPTION OF THE PREFERRED EMBODIMENT

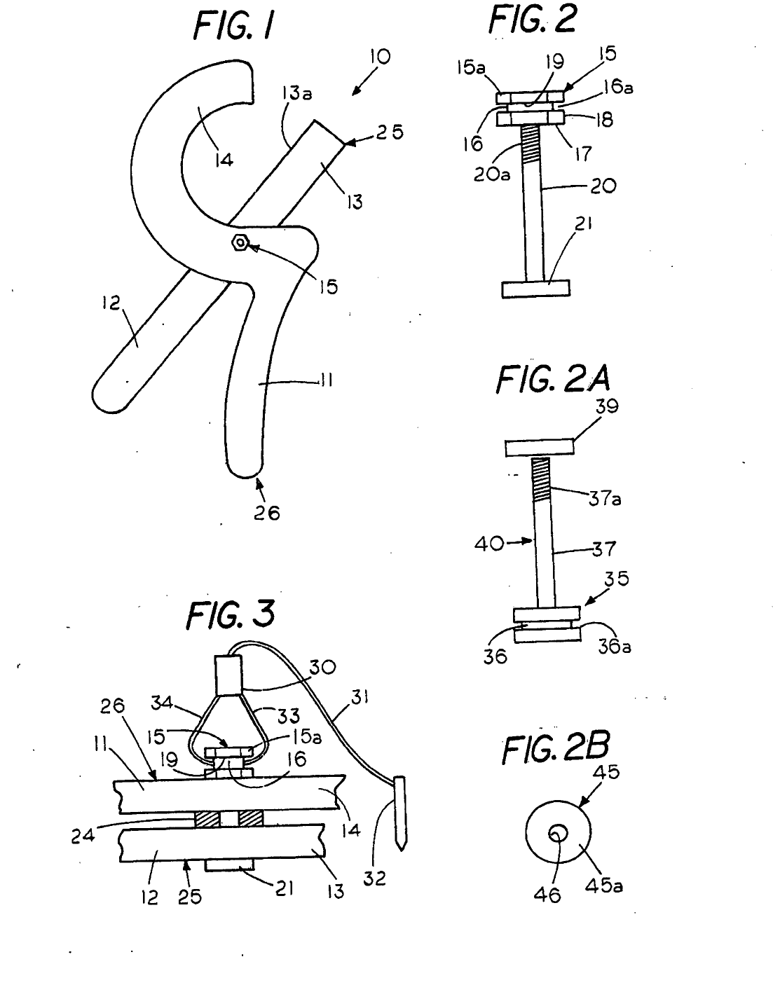

FIG. 1 shows a groundable pipe cutter 10 for cutting polymer plastic pipes such as PVC pipes. In one example the groundable pipe cutter comprises a first pivotal member 25 having a handle 12 on one end for grasping in a users hand with the opposite end of the pivotal member 12 comprising an electrically conducting metal blade 13 for shearing a polymer pipe. A second pivotal member 26 includes a handle 11 on one end for grasping in a users hand with the opposite end having a curved jaw 14 for cradling a pipe therein as the cutting edge 13a on blade 13 is forced through the pipe by squeezing together handles 11 and 12. That is, hand squeezing of handles 11 and 12 causes the pivotal members 25 and 26 to pivot about an electrically conductive metal pivot pin 15 which extends through both members 25 and 26 to hold pivotal members 25 and 26 in a plane so that the pivoting action of the handles maintains the alignment of blade 13 with jaw 14 during a pipe cutting operation. Handles 11 and 12 may be made of aluminum although other rigid materials may be used.

FIG. 2 is an isolated view of the electrically conductive pivot pin 15 that also functions as a terminal for connection of a ground thereto. Pivot pin 15 comprises an electrically conductive cylindrical shank 20 having a retaining head 21 on one end and a terminal nut 15a on the opposite end that includes female threads (not shown) for threadingly engaging with male threads 20a on shank 20 to secure the pivotal members 25 and 26 in an operative condition. That is, the pivot pin 15 extends through the handles 11 and 12 while the terminal nut 15a on the pivot pin 15 maintains the handles proximate each other in a shearing or cutting condition during use of the pipe cutter 10. The terminal nut 15a includes an annular head that extends radially outward from a cylindrical shaft 16 to provide an annular lip 19 for maintaining axial mechanical engagement with a spring loaded grounding connector clamp while the exterior surface of shaft 16 can form radially contact with the ends of a ground connector clamp. Located proximate to terminal nut 15a is a washer 18 that has a surface 17 for engaging one of the pivotal members 25 and 26 to hold the pivotal members in a pivoting condition proximate each other. Washer 18 may be attached to nut 15a or may be a separate item. In this example, an annular recess 16a is located between nut 15a and washer 18 and forms an opening for placing ends of a grounding clamp therein and into electrical contact with shaft 16.

Typically, the handles 11 and 12 as well as other portions of the pipe cutter may contain a protective coating to prevent oxidation of the pipe cutter. Unfortunately, the protective coating may act like an electrically insulator making it difficult to ensure that one can ground the pipe cutter. The use of a terminal pivot pin, which can be maintained free of material that may act as an electrically insulator, allows the user to ground the pipe cutter while on the go. In addition, since the terminal pivot pin 15 extends outward from the groundable pipe cutter a user can from time to time remove any field residue on the terminal pin to ensure that a clamp attached thereto forms an electrical connection to the terminal pin. To further ensure a low resistance electrical connection the pivot pin 15 may be formed of a material such as stainless steel as well as the cutting blade 13a, which inhibits corrosion. In addition the use of the pivot pin 15 for engagement with the pivotal members 11 and 12 generates a scouring action therebetween that helps maintain an electrical path between the pivotal members 11 and 12 and a grounding assembly attached thereto. In one example, the head 21 may be secured directly to the blade 13 or some other feature through welding or the like to ensure that one has a low resistance electrical connection between the blade 13 and the terminal 15.

FIG. 3 shows an isolated portion of the groundable pipe cutter 10 with the pivotal members 25 and 26 supported in a pivotal relationship to each other though the terminal pivot pin 15. A washer or annular spacer 24 provides bearing surfaces between pivotal member 25 and 26. The head 21 is in electrical contact with blade 13 through either frictional or welded contact. In the example shown in FIG. 3 a hand operable spring or compression clamp 30 having a first electrically conducting resilient leg 33 and a second electrically conducing resilient leg 34 are shown with the legs in electrical engagement with opposite sides of inset shaft 16 on terminal pivot pin 15 through the pressure exerted on opposite side of pins by the compression clamp 30. That is, the ends of clamps 33 and 34 exert a radial inward pressure on shaft 16 to provide an electrical path from the pivot pin 15 to the clamp 30. The lip 19a provides an axial restraint to prevent clamp 30 from being accidentally pulled off of shaft 16 during a pipe cutting operation. In this example, a flexible electrical wire 31, which attaches to one end of spring clamp 30 connects to a pointed ground rod 32 that can be inserted into the ground by a user. As an alternate the clamp 30 may be connected to an existing grounded object, for example by use of spring clamp in place of the grounding rod 32. In still other examples one may have a ground wire having a first end permanently connected to the electrical terminal 15a through soldering or the like. In the example shown nut 15a and clamp 30 maintain one end of the electrical wire 31 in electrical and mechanical engagement with each other, while a second end of the electrical wire 31 is in condition for attachment to an electrical ground to thereby direct static electricity encountered by the pipe cutter to an electrical ground.

The use of the terminal post 15 as a connection point for an external ground ensures that the pipe cutter can be grounded when in use. That is, since the pivot pin 15 pivotal supports the pivot member 25 and 26 and is in electrical contact with blade 13 there is a direct electrical path from the cutting blade 13 to the ground. In addition the terminal post 15 can be maintained free of a protective covering such as paint or the like that may act as an insulator rather than an electrical conductor. As illustrated in FIG. 1 the terminal post 15 is laterally spaced or offset from a pipe that may be cut in the pipe cutter jaws 14 and 13 thus avoiding accidental entanglement of the wire 31 with the pipe being cut. The location of the terminal at pivot pin 15, which pivotally supports the pivoting of members 11 and 12, has the feature of eliminating movement of the terminal, which may accidentally dislodge the ground. For example, if the ground terminal was attached to the end of either the handle 11 or 12 the ground member such as clamp 30 may accidentally interfere with or get dislodged as the handles 11 and 12 are brought together from an open condition to a closed condition.

The use of a pivot pin as a grounding terminal for the pipe cutter 10 provides benefits, however, if desired the ground terminal on the pipe cutter may be separate from the pivot pin as long as the ground terminal provides a ground path from the blade 13a to the external ground. For example, a ground terminal may be attached directly to the blade 13a or the blade 13a may contain an integral grounding terminal such as a relief or a hole within the blade that allows one to attach a ground wire directly to the blade.

In this example the annular recess, 16a which is formed between washer 18 and terminal head 15a is sufficiently large that the jaws 33 and 34 of a resilient clamp can be clamped around the shaft 16 with the terminal head 15a axially restraining the jaws of clamp 30 thereon while providing an electrical connection therebetween.

In the example shown a clamp 30, which is connected to shaft 16, forms the connection point to an external ground so that the electrical path from the blade 13 to the shaft 16 extends through the junction of the male treads 20a on shaft 20 and the female threads in nut 15a. FIG. 2A shows an alternate embodiment where the connection point to the external ground is formed on a pivot pin 40 though a head 35 which has a lip 36a and a shaft 36. Pivot pin 40 includes shaft 37 with threads 37a and a nut 39, although other means of securing the pivot pin to the jaws 25a and 26 may be used. For example, nut 39 may be replaced by a permanent head, which is formed to shaft 37. In this example one has the benefit of eliminating an electrical path between the male and female threads. In addition, if the head 35 is welded or otherwise connected to the blade the electrical resistance to ground can be further reduced thus ensuring an excellent ground for the pipe cutter since the parts become integral to each other.

In the example shown the terminal pivot pin 15 and the blade 13 are separate items that have surfaces that move relative to one another, however, it is envisioned that the pivot pin 15 may be welded or otherwise secured to the blade 13 to ensure a low resistance path from the cutting blade to the pivot pin.

While the pipe cutter is shown with a removable spring clamp 30 attachable to the exterior of pivot pin 15 it is envisioned that other types of connectors may be used to temporarily form an electrical ground to the pipe cutter. FIG. 2B shows an end view of another example of terminal stud 45 where the head 45a includes a socket 46 for inserting an electrical plug such as a banana plug therein in order to form an electrical connection between a ground wire and the pipe cutter. While the examples show the temporary attachment of the ground to a terminal on the pipe cutter in some instance the ground wire 31 may be permanently attached to the pivot pin 15 without departing from the spirit and scope of the invention.

I claim:

1. A groundable polymer plastic pipe cutter for safely cutting pipes that may contain a flammable fluid therein comprising:
a pipe jaw;
an electrically conductive blade;
an electrically conductive terminal pivot pin in electrical and mechanical engagement with said blade, said terminal pivot pin having a terminal head extending outward from a surface of the pipe cutter whereby the pipe cutter can be in situ grounded by attaching a spring clamp to the terminal pivot pin.

2. The pipe cutter of claim 1 wherein the pivot pin has an annular lip for axially restraining a connector thereon and the annular lip is located in a head of the pivot pin.

3. The pipe cutter of claim 1 wherein the pivot pin includes a nut having a female thread for engaging a male thread of said pivot pin for forming an electrical path therebetween.

4. The pipe cutter of claim 1 including a compression clamp secured to the pivot pin with the compression clamp connected to a ground member through a flexible wire.

5. The pipe cutter of claim 1 wherein the pivot pin is a metal pivot pin and the blade is a metal blade.

6. The pipe cutter of claim 1 wherein the pipe cutter contains at least one curved jaw for cradling a pipe therein during a cutting operation.

7. The pipe cutter of claim 1 wherein the terminal pivot pin includes a nut having an annular recess there around forming a lip for axially restraining a ground clamp thereon.

8. The pipe cutter of claim 1 wherein the blade is fixedly secured to the pivot pin.

9. The pipe cutter of claim 1 including a ground rod and a spring clamp with a flexible electrically conducting wire having one end attached to the ground rod and the other end attached to the spring clamp to thereby complete an on the go grounding circuit for the pipe cutter.

10. A pipe cutter for cutting pipes that may contain a flammable fluid therein comprising:
a first handle having a pipe jaw;
a pivot pin;
a second handle having an electrically conductive blade with said second handle and said first handle pivotable about said pivot pin ;
an electrical grounding terminal; and
a ground wire having a first end connected to the electrical grounding terminal and a second end for attachment to an electrical ground to thereby direct static electricity in the pipe cutter to the electrical ground.

11. The pipe cutter of claim 10 wherein the pivot pin includes an annular head for engagement with the ground wire and the electrical grounding terminal comprises the pivot pin.

12. The pipe cutter of claim 10 wherein the electrically grounding terminal comprises. a socket in the pivot pin.

13. The pipe cutter of claim 10 wherein the pivot pin includes a head with an annular lip for on-the-go engaging of an electrical connector thereto.

14. The pipe cutter of claim 10 wherein the fist handle and the second handle are hand squeezable about the pivot pin and the ground terminal is integral to the pivot pin.

15. A method of cutting a polymer plastic pipe while preventing static electricity from igniting a flammable material thereto comprising:
attaching a ground clamp to a cutting blade of a groundable pipe cuter; and
cutting the pipe by pivoting a cutting blade about the terminal pivot pin.

16. The method of claim 15 including the step of securing a ground clamp beneath a lip on a terminal pivot pin.

17. The method of claim 15 including the step of attaching the ground clamp to a ground rod through a flexible wire.

18. The method of claim 16 including the step of forming pressure engagement between the ground clamp and the terminal pivot pin.

19. The method of claim 15 including securing a first handle of the groundable pipe cutter to a second handle of the groundable pipe cutter by extending the terminal pivot pin threrethrough.

20. The method of claim 19 including securing a nut to an end of the terminal pivot pin to form an electrical conductive path through a pivotal relationship between a first pivotal member and a second pivotal member.
